(19) United States
(12) Patent Application Publication
(10) Pub. No.: US 2009/0079746 A1
(43) Pub. Date: Mar. 26, 2009

(54) SWITCHING BETWEEN GRAPHICS SOURCES TO FACILITATE POWER MANAGEMENT AND/OR SECURITY

(75) Inventors: Brian D. Howard, Portola Valley, CA (US); Paul A. Baker, Los Altos, CA (US); Michael F. Culbert, Monte Sereno, CA (US); David G. Conroy, El Granada, CA (US); William C. Athas, San Jose, CA (US)

Correspondence Address: PVF -- APPLE INC.;c/o PARK, VAUGHAN & FLEMING LLP, 2820 FIFTH STREET, DAVIS, CA, 95618-7759, US

(73) Assignee: APPLE INC., Cupertino, CA (US)

(21) Appl. No.: 11/858,358

(22) Filed: Sep. 20, 2007

(51) Int. Cl. G06F 15/16

(52) U.S. Cl. 345/502

(57) ABSTRACT

One embodiment of the present invention provides a system that switches between frame buffers which are used to refresh a display. During operation, the system refreshes the display from a first frame buffer which is located in a first memory. Upon receiving a request to switch frame buffers for the display, the system reconfigures data transfers to the display so that the display is refreshed from a second frame buffer which is located in a second memory.

### RELATED APPLICATION

The present application is related to pending U.S. patent application Ser. No. 11/449,167 filed on 4 Aug. 2006 by inventors David G. Conroy, Michael F. Culbert, William C. Athas and Brian D. Howard, entitled “Method and Apparatus for Switching Between Graphics Sources” (Attorney Docket No. APL-P4406US1).

### BACKGROUND

1. Field of the Invention

The present invention relates to techniques for switching between graphics sources in computer systems. More specifically, the present invention relates to a method and an apparatus for reducing power and/or improving security by switching between graphics sources in a computer system.

2. Related Art

Rapid advances in computing technology have made it possible to perform trillions of computational operations each second on data sets that are sometimes as large as a trillion bytes. These advances can be largely attributed to the exponential increase in the size and complexity of integrated circuits. Unfortunately, the increase in size and complexity of integrated circuits has been accompanied by a similar increase in power consumption.

In a parallel development, the rapid proliferation of broadband wireless networks has given rise to a dramatic increase in the number of portable computer systems. Unfortunately, portable computer systems usually have stringent power constraints due to the limited battery power that is available to them. These developments have created a significant need for power-saving techniques.

Advances in 3D graphics technology have led most of the modern computer systems to use dedicated graphics processors (sometimes referred to as graphics processing units (GPUs)) to drive graphics display devices. Unfortunately, today's GPUs consume a large amount of power, which severely shortens the battery life of portable computer systems, and also causes heat dissipation problems.

While a graphics display is operating, there are often times when very little graphics processing is needed, for example when the user is reading a document on the display. Unfortunately, existing graphics processors cannot easily switch to a low-power mode to conserve power during these “low activity” periods.

One technique for saving power during such “low activity” periods is to switch the display from a high-power graphics source (e.g., a high-performance GPU) to a low-power graphics source (e.g., a low-performance GPU). Ideally, this switching operation should be invisible to the user, so that the system can seamlessly switch back and forth between the different graphics sources as the graphics processing demands change, or as the system's need to limit power consumption changes.

One existing technique provides a mechanical switch which allows a user to switch between a lower-performance graphics source and a higher-performance graphics source. However, this brute-force technique requires the user to fully re-initialize the computer system each time the user switches from one graphics source to another. Requiring a user to re-initialize the computer system to switch from one graphics source to another is simply not acceptable in many situations. An initialization process is one of the most disruptive operations that can be performed on the computer. Typically the user has to save all his or her work before re-initializing the computer, which can take a considerable amount of time. Furthermore, the user must first decide whether their graphics processing requirements will be high or low in the near future, and must then wait for the system to re-initialize, and then be willing to wait for another re-initialization if requirements change.

Another problem is that some graphics processors render images into a frame buffer located in insecure main memory. This can cause issues with Digital Rights Management (DRM) standards which require that such graphical images be stored securely.

Hence, what is needed is a method and an apparatus that facilitates rapid and/or seamless switching between different graphics sources to reduce power and/or provide security.

### SUMMARY

One embodiment of the present invention provides a system that switches between frame buffers which are used to refresh a display. During operation, the system refreshes the display from a first frame buffer which is located in a first memory. Upon receiving a request to switch frame buffers for the display, the system reconfigures data transfers to the display so that the display is refreshed from a second frame buffer which is located in a second memory.

In some embodiments, the first memory is a main memory, which is accessible by numerous applications and is hence insecure, and the second memory is a secure frame buffer which is located outside of main memory.

In some embodiments, switching the display additionally involves transferring data which is used to refresh the display so that the data completely bypasses the insecure main memory. In this variation, the system encrypts the data while the data is stored in the second frame buffer and while the data is in transit to and from the second frame buffer.

In some embodiments, prior to receiving the request to switch frame buffers, the system: determines a security requirement for data associated with the display; and generates the request to switch frame buffers based on the determined security requirement.

In some embodiments, prior to receiving the request to switch frame buffers, the system: monitors a level of graphics-processing load for the display; and generates the request to switch based on the level of graphics-processing load.

In some embodiments, the system: measures a temperature in a computer system which contains the display; and generates the request to switch based on the measured temperature.

In some embodiments, switching the display so that the display is refreshed from the second frame buffer additionally involves switching a graphics processing unit (GPU) which performs rendering operations for the display. In some embodiments, the GPU is switched between a low-power GPU, which renders to the first frame buffer, and a high-power GPU which renders to the second frame buffer.

In some embodiments, prior to switching from the low-power GPU to the high-power GPU, the system substantially synchronizes the low-power GPU's output display signals and the high-power GPU's output display signals, thereby facilitating a seamless transition which does not disrupt graphical output on the display.

In some embodiments, substantially synchronizing the output display signals involves using one or more phase-locked loops (PLL).

In some embodiments, the switching takes place during a vertical blanking interval associated with a vertical blanking signal for the display.

Another embodiment of the present invention provides a computer system that switches between a first graphics processor and a second graphics processor to drive a first display and/or a second display. This computer system includes: a processor; a memory; a first graphics processor; a second graphics processor; a first display, and a second display. The computer system also includes a first switch, which selectively couples either the first graphics processor or the second graphics processor to the first display. It also includes a second switch, which selectively couples either the first graphics processor or the second graphics processor to the second display.

In some embodiments, the first display is an internal display, which is integrated into the computer system, and the second display is an external display, which is coupled to the computer system.

In some embodiments, the first switch and the second switch are configured either to couple the first graphics processor to both the first display and the second display, or to couple the second graphics processor to both the first display and the second display.

In some embodiments, the first graphics processor is a high-power graphics processing unit (GPU) and the second graphics processor is a low-power GPU.

In some embodiments, the system includes a synchronization mechanism, which is configured to substantially synchronize the first graphics processor's output display signals and the second graphics processor's output display signals, thereby facilitating a seamless switching process which does not disrupt graphical output.

In some embodiments, the synchronization mechanism is configured to use one or more phase-locked loops (PLL) to substantially synchronize the output display signals.

In some embodiments, the first switch and the second switch can include: multiplexers; or wired-OR logic.

### BRIEF DESCRIPTION OF THE FIGURES

FIG. 1 illustrates a computer system in accordance with an embodiment of the present invention.

FIG. 2 illustrates a computer system which can switch between different graphics sources to drive the same display in accordance with an embodiment of the present invention.

FIG. 3 presents a flow chart illustrating the process of switching from a first graphics source to a second graphics source to drive a display in accordance with an embodiment of the present invention.

FIG. 4 presents a flow chart illustrating the process of switching from the first graphics source to the second graphics source without synchronizing the output display signals in accordance with an embodiment of the present invention.

FIG. 5A illustrates a single vertical blanking interval (VBI) and a corresponding vertical synchronization (V-sync) pulse generated by a graphics source in accordance with an embodiment of the present invention.

FIG. 5B illustrates two overlapping VBIs generated by two graphics sources in accordance with an embodiment of the present invention.

FIG. 6A presents a schematic of a technique for synchronizing timing signals between two graphics sources in accordance with an embodiment of the present invention.

FIG. 6B presents a schematic of another technique for synchronizing timing signals between two graphics sources in accordance with an embodiment of the present invention.

FIG. 7 illustrates a computer system comprising two graphics sources in accordance with an embodiment of the present invention.

FIG. 8 presents a flow chart illustrating the process of switching from the first graphics source to the second graphics source in accordance with an embodiment of the present invention.

FIG. 9 presents a flow chart illustrating the process of switching from the second graphics source to the first graphics source in accordance with an embodiment of the present invention.

FIG. 10 illustrates a computer system which can switch between different graphics sources to drive an internal display and an external display in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Computer System

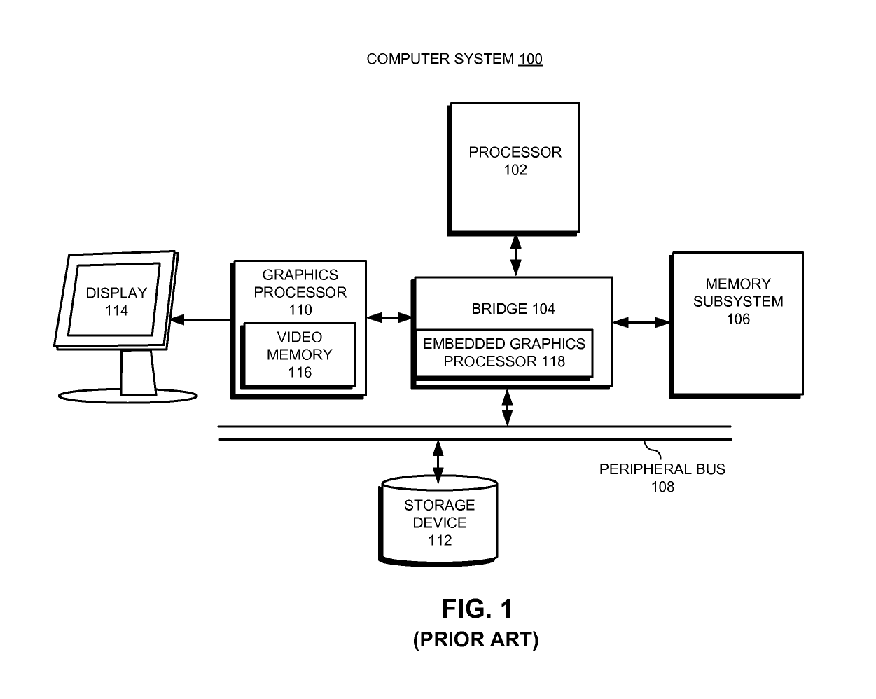

FIG. 1 illustrates a computer system 100 in accordance with an embodiment of the present invention. As illustrated in FIG. 1, computer system 100 includes processor 102, which is coupled to a memory subsystem 106, peripheral bus 108, and to a graphics processor 110 through bridge 104. Bridge 104 can include any type of core logic unit, bridge chip, or chipsets that are commonly used to couple together components within computing system 100. In one embodiment of the present invention, bridge 104 is a north bridge chip. Processor 102 can include any type of processor, including, but not limited to, a microprocessor, a digital signal processor, a device controller, or a computational engine within an appliance.

It should be recognized that one or more components of the computer system 100 may be located remotely and accessed via a network.

Processor 102 communicates with memory subsystem 106 through bridge 104. Memory subsystem 106 can include a number of components, including one or more memory chips which can be accessed by processor 102 at high speed.

Processor 102 also communicates with storage device 112 through bridge 104 and peripheral bus 108. Storage device 112 can include any type of non-volatile storage device that can be coupled to a computer system. This includes, but is not limited to, magnetic, optical, and magneto-optical storage devices, as well as storage devices based on flash memory and/or battery-backed up memory.

Processor 102 additionally communicates with graphics processor 110 through bridge 104. Graphics processor 110 is a specialized graphics-rendering device that provides a signal source to display 114 and drives display 114. Display 114 can include any type of display device that can present information in a visual format (including images and text) to a user. This includes, but is not limited to, cathode ray tube (CRT) displays, light-emitting diode (LED) displays, liquid-crystal displays (LCD), organic LED (OLED) displays, surface-conduction electron-emitter displays (SED), or electronic paper.

Graphics processor 110 performs both 2D and 3D graphics-rendering operations, such as lighting, shading and transforming, with high performance. To achieve the high performance, graphics processor 110 may utilize dedicated video memory 116 to store frame buffers, textures, vertex arrays, and/or display lists.

Bridge 104 also includes an embedded graphics processor 118. Embedded graphics processor 118 is typically built for modest performance graphics processing purposes, and hence consumes much less power than graphics processor 110. Note that in FIG. 1, embedded graphics processor 118 is not directly coupled to and does not drive display 114.

Note that although the present invention is described in the context of computer system 100 illustrated in FIG. 1, the present invention can generally operate on any type of computing device that supports more than one graphics processor. Hence, the present invention is not limited to the computer system 100 illustrated in FIG. 1.

### Selectively Switching Between Graphics Sources

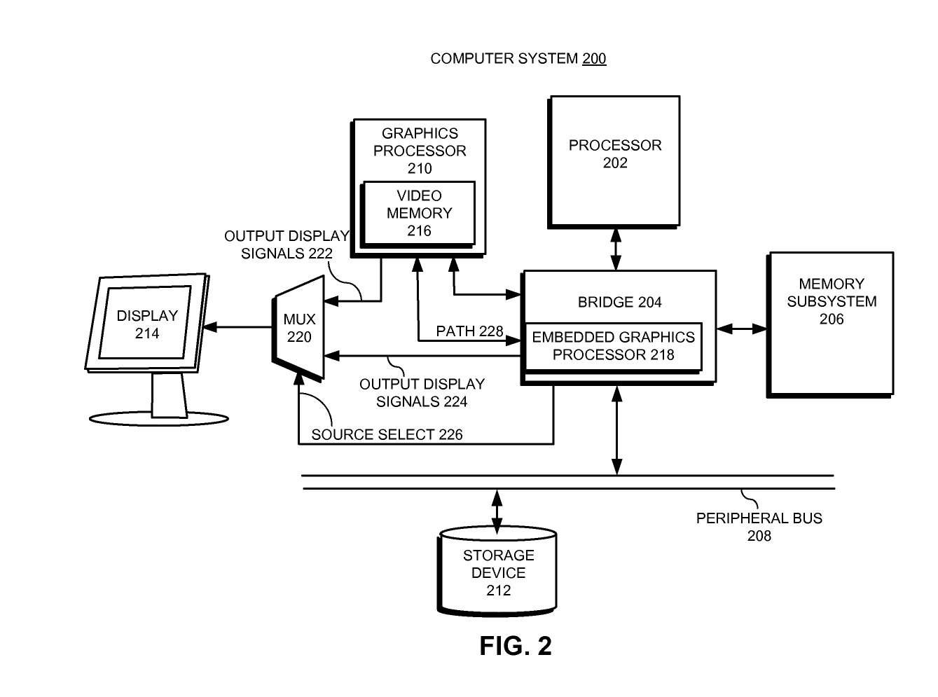

FIG. 2 illustrates a computer system 200 which can switch between different graphics sources to drive the same display in accordance with an embodiment of the present invention. Note that in FIG. 2, the two graphics sources (graphics processor 210 and embedded graphics processor 218) can each independently drive display 214. However, the graphics source that actively drives display 214 at a given time is determined by selecting device 220 which can select between the two graphics sources. Specifically, computer system 200 can use selecting device 220 to select a graphics source based on its current operation conditions.

More specifically, output display signals 222 from graphics processor 210, and output display signals 224 from embedded graphics processor 218 are both coupled to inputs of a two-to-one multiplexer (MUX) 220. The output of MUX 220 is controlled by source select 226, which determines which one of the two graphics sources should drive display 214. In this embodiment, source select 226 is the output of bridge chip 204, which comprises specific logic for generating source select 226. Note that source select 226 can also be produced by a logic block other than bridge 204.

The output display signals from the selected graphics source are then coupled to the inputs of display 214 to actively drive it. Although the selecting device is shown as a multiplexer, it can also include any other type of selecting device, such as a simple wired-OR logic.

In one embodiment of the present invention, graphics processor 210 and embedded graphics processor 218 can cooperate through a path 228, so that they can synchronize their output display signals. Because the output display signals can include both timing signals and data signals, synchronizing the output display signals can involve synchronizing both the respective timing signals and the respective data signals. Note that path 228 can be realized using hardware and/or software to facilitate synchronizing the two graphics sources.

In one embodiment of the present invention, graphics processor 210 is a high-performance graphics processor unit (GPU) which consumes a large amount of power, whereas embedded graphics processor 218 is a lower-performance GPU which consumes a smaller amount of power. In this embodiment, when the graphics processing load is light, the system switches the graphics source from graphics processor 210 to embedded graphics processor 218 to drive display 214, and subsequently powers down graphics processor 210 entirely, thereby saving power. On the other hand, when the graphics processing load becomes heavy again, the system switches the graphics source from embedded graphics processor 218 back to graphics processor 210.

Note that although we have described switching between graphics processors in the context of a standalone graphics processor and an integrated graphics processor illustrated in FIG. 2, the present invention can generally work for a computer system comprising two or more graphics processors, wherein each of the graphics processors can independently drive the display when properly configured. Moreover, these multiple graphics processors can have different operating characteristics, including different power consumption levels. Furthermore, each of the multiple graphics processors can be either a standalone graphics processor or an integrated graphics processor within a chip. Hence, the present invention is not limited to the computer system 200 illustrated in FIG. 2.

Note that the above-described technique for switching between different graphics sources does not require shutting down the computer system or re-initializing the computer system. As a result, the switching process can take substantially less time than it would have if a re-initialization had been required. Consequently, the present invention allows rapid and frequent switching between the graphics processors.

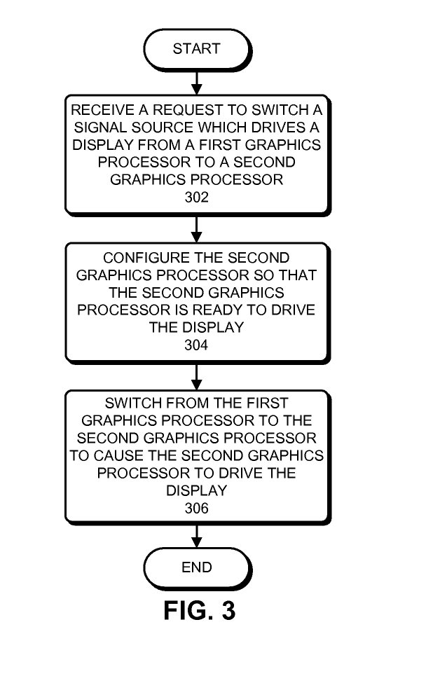

FIG. 3 presents a flowchart illustrating the process of switching from a first graphics source to a second graphics source to drive a display in accordance with an embodiment of the present invention.

During operation, the system first receives a request to switch the signal source for the display from a first graphics processor which is actively driving the display to a second graphics processor which is in a non-active state (step 302).

The switching request can be generated by a user who is aware of levels of graphics processing load. Alternatively, the switching request can be generated internally by the system.

In one embodiment of the present invention, system software continuously monitors the level of graphics processing load. More specifically, the system can determine the level of graphics processing load based on a condition in a graphics command queue associated with the graphics processor. For example, if the command queue is mostly empty, the system asserts a low graphics processing load. On the other hand, if the command queue is mostly full, the system asserts a high graphics processing load.

Next, based on the level of the graphics processing load, the system software selects one of the two graphics processors, and subsequently generates the request to switch if the non-active graphics processor is selected.

For example, if the first graphics processor is a high-performance GPU that consumes high power, when the system software detects a considerable decrease in the level of graphics processing load, the system software can issue a request to switch to a second graphics processor which has lower performance, but which also consumes much less power. On the other hand, if the first graphics processor is a lower-performance and low-power GPU, the system can issue a request to switch to a high-performance and high-power GPU if the system software detects a considerable increase in the level of graphics processing load.

Note that using system software to monitor the graphics processing load and to automatically issue the switching request is significantly faster and possibly more energy efficient than a human-initiated request. Furthermore, using system software can free the user from the monitoring job.

Next, in response to the switching request, the system configures the second graphics processor in preparation for driving the display (step 304). In one embodiment of the present invention, configuring the second graphics processor can involve one or more of the following steps: (1) powering up the processor if it is currently powered down; (2) initializing the graphics processor; and (3) generating output signals in preparation for powering up the display.

The system then switches the signal source which drives the display from the first graphics processor to the second graphics processor, which causes the second graphics processor to drive the display (step 306). In one embodiment of the present invention, the switching involves using a selecting device such as MUX 220 in FIG. 2, which decouples the first graphics processor from, and couples the second graphics processor to, the display. During the switching operation, different timing controls can be used which will be described in more detail below. In general, obtaining a smoother switching transition requires more precise timing control and, hence, typically requires a more complex switch-controlling mechanism.

Once the second graphics processor takes over from the first graphics processor, the system may power down the first graphics processor to conserve power. Note that the above-described switching process does not require re-initializing the whole system to take effect.

Note that although we have described switching based on graphics processing load, the switch request can also be generated based on power conditions (e.g., whether the system is running on a battery or an external power source, or whether the battery is low), based on a need to reduce system heat dissipation, based on user preference, or based on any feature or capability that is different between the two graphics processors.

### Timing During Switching

Switching between different graphics processors to drive the same display device requires a certain level of cooperation between the graphics processors to ensure a substantially seamless transition. We discuss different timing techniques during a switching below by distinguishing them based on whether synchronization is involved in the output display signals.

Switching without Synchronization

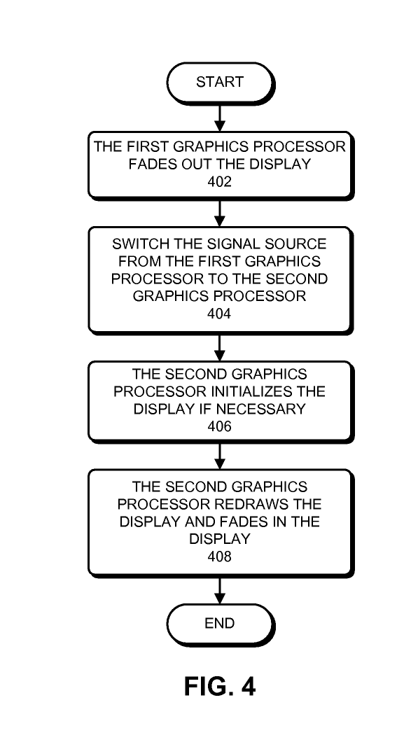

FIG. 4 presents a flowchart illustrating the process of switching from the first graphics source to the second graphics source without synchronizing the output display signals in accordance with an embodiment of the present invention.

During operation, the first graphics processor fades out the display (step 402). Note that this can be done in a number of ways, including, but not limited to, displaying black or other colors on the screen, turning off the backlight, or powering down the entire display.

Next, the system switches the signal source that drives the display from the first graphics processor to the second graphics processor, which has been configured to drive the display (step 404). More specifically, the switching involves decoupling the first graphics processor's output signals from the input of the display and coupling the second graphics processor's output signals to the input of the display.

Upon completing the switching, the second graphics processor then initializes the display if necessary (step 406). Next, the second graphics processor redraws the display screen and subsequently fades in the display screen (step 408).

In this embodiment, the two graphics sources are not required to synchronize with each other. Consequently, the second signal source does not need to be configured to redraw the display before the switch takes place. Furthermore, the first signal source can be turned off (e.g., through a fade-out operation) prior to performing the switch.

Note that switching without synchronization is simple but can cause the user to notice the switch. However, if the switching can be completed within a fraction of a second, the user may not even notice the switch. Alternatively, if the switching is done more slowly, the visual disruption can be reduced by using an appropriate visual effect, such as a fade-out/fade-in effect when the display resolution is changed. Generally, any undesirable visual effects of switching the display from one set of display signals to a different, unsynchronized set of display signals can be hidden by fading out the display during the transition.

Switching with Synchronization

Synchronizing the output signals prior to switching facilitates a smoother, less noticeable, or even seamless switching process which does not disrupt graphical output on the display. However, the synchronization requires the second graphics source to start generating output signals in preparation for driving the display prior to the switching, so that the output display signals from both graphics sources can be synchronized.

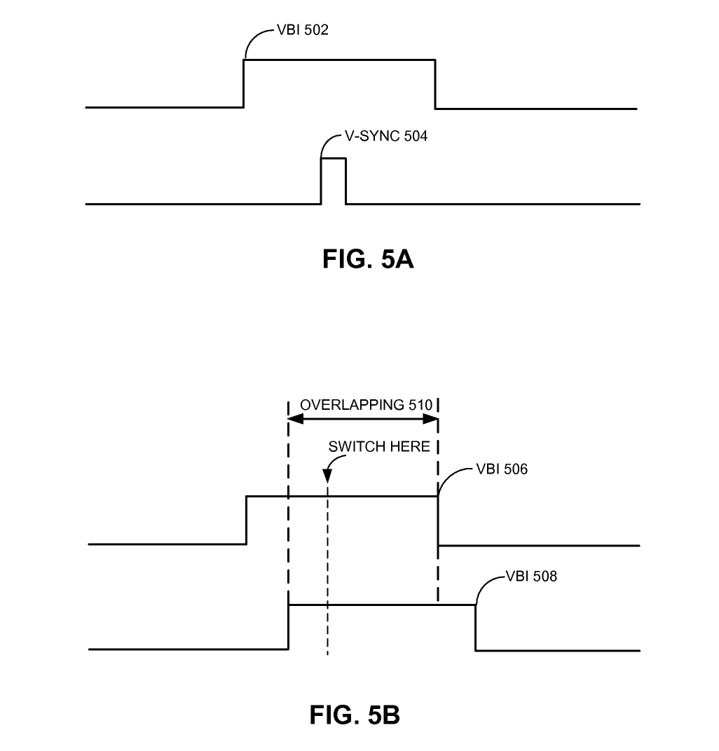

In one embodiment of the present invention, synchronizing the output signals from the two graphics sources can be achieved by matching up timing information embedded in the output signals. Such timing information can include, but is not limited to, horizontal synchronization (H-sync) pulses, vertical synchronization (V-sync) pulses, horizontal blanking signals, and vertical blanking signals. In particular, V-sync pulses control image refresh on the display by indicating when to start scanning a new frame of data. Typically, V-sync pulses occur within a short time interval between two consecutive image frames, referred to as a vertical blanking interval (VBI), during which the display on the screen is held in a constant state for various housekeeping purposes. FIG. 5A illustrates a single VBI 502 and a corresponding V-sync pulse 504 produced by a graphics source in accordance with an embodiment of the present invention. Note that the V-sync pulse 504 falls within VBI 502.

In this embodiment, the computer system keeps track of when V-sync pulses occur in the first graphics source, and adjusts the timing sequence of the second graphics source until its V-sync pulses are aligned with those of the first graphics source. In one embodiment, aligning the V-sync pulses from the two graphics sources involves using either software or hardware to cause the timing sequence of the second graphics source to coincide with the timing sequence of the first graphics source. During this alignment period, the first graphics source continues to drive the display. When the V-sync pulses are sufficiently aligned between the two sources, switching can then be performed during a next VBI.

FIG. 5B illustrates two overlapping VBIs-VBI 506 and VBI 508 generated by two graphics sources in accordance with an embodiment of the present invention. Note that the switching occurs within overlapping period 510 of the two VBIs. Also note that the switching process may appear invisible to a user if it can be completed within overlapping period 510. Furthermore, the substantial synchronization between the two graphics sources facilitates the second graphics source to start driving the display immediately so that it appears to the user as if the display did not change.

However, it is possible for the switching process to take longer than a single VBI to complete, or to take up a few frame times to resolve. In this case, the system can hide the switching effect by blanking or fading out the screen completely.

In another embodiment of the present invention, instead of causing the second graphics source to align with the first, the system can allow the V-sync signals of the second graphics source to drift against those of the first graphics source. Such a drift in the timing signals can occur as a result of one or more timing differences. For example, the drift can be caused by a slight difference in the clock frequencies of two graphics processors. Alternatively, the drift can be caused by programming the two graphics processors to operate at slightly different display frame rates.

In this embodiment of synchronization, the system can monitor the two V-sync signals from the two sources and detect when they overlap with each other, wherein the monitoring can be performed by either software or hardware. When this occurs, the system can switch from one graphics source to the other before the two signals drift away from each other.

Switching with Hardware-Based Synchronization

In one embodiment of the present invention, one of the graphics sources can be synchronized to the other graphics source using additional hardware, so that the display output timing of the two graphics sources can be aligned precisely. A switch can then be made during a next VBI so that the switch is undetectable by the user. In this embodiment, a smoother switch is made possible by incorporating the additional hardware to adjust the phase and frequency of the second graphics source's display timing generator to align the display output timing to that of the first graphics source.

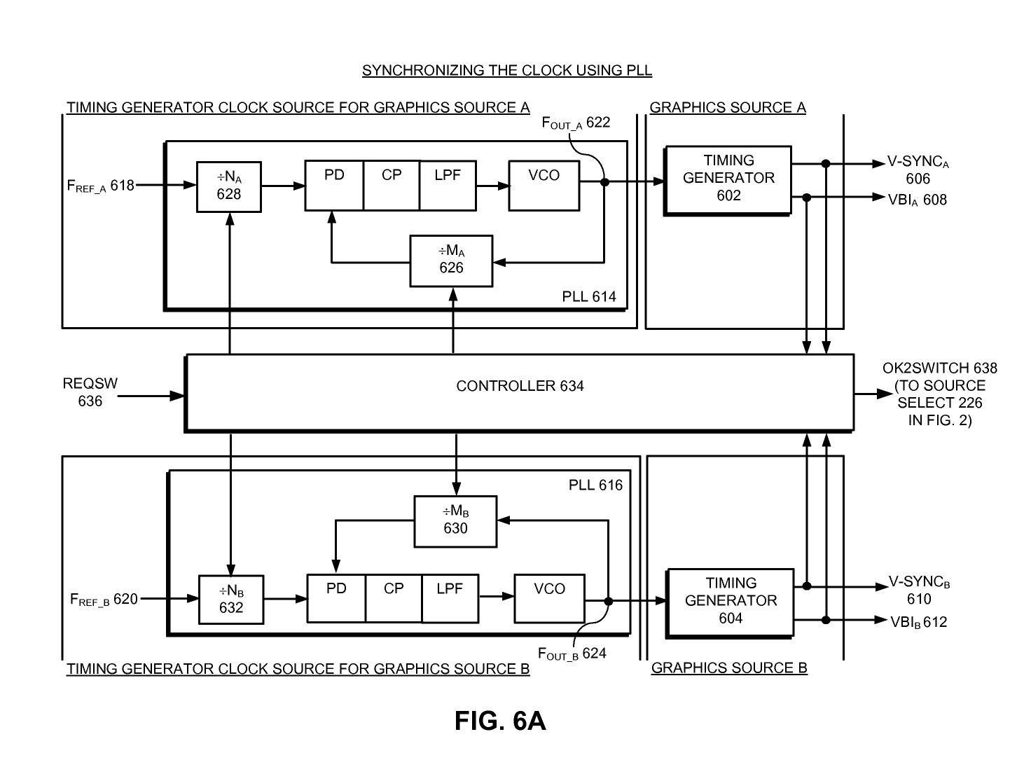

FIG. 6A presents a schematic of a technique for synchronizing timing signals between two graphics sources in accordance with an embodiment of the present invention. As illustrated in FIG. 6A, the two graphics sources A and B comprise timing generator 602 and timing generator 604, respectively. Timing generator 602 produces V-sync pulses in output V-SYNC 606 and vertical blanking intervals in output VBI 608 for graphics source A, while timing generator 604 produces V-sync pulses in output V-SYNC 610 and vertical blanking intervals in output VBI 612 for graphics source B.

Graphics sources A and B also use phase-locked loop (PLL) 614, and PLL 616 to provide frequency references for timing generators 602 and 604, respectively. More specifically, PLL 614 and PLL 616 receive reference frequency inputs f^{A}_{REF} 618 and f^{B}_{REF} 620 from the left, and generate reference frequency outputs f^{A}_{OUT} 622 and f^{B}_{OUT} 624 as inputs to timing generators 602 and 604. A detailed explanation of the functions of a PLL and associated components can be found in a number of references that describe PLLs (see Floyd M. Gardner, “Charge-Pump Phase-Lock Loops,” IEEE Transactions on Communications, Vol. 28, No. 11, November 1980).

For frequency synthesizing purposes, PLL 614 comprises a divider M_{A} 626 and a divider N_{A} 628. Similarly, PLL 616 comprises a divider M_{B} 630 and a divider N_{B} 632. The output of PLL 614 and PLL 616, when phase locked, produce output frequency f^{A}_{OUT}=F^{A}_{REF}×(M_{A}/N_{A}), and f^{B}_{OUT}=f^{B}_{REF}×(M_{B}/N_{B}), respectively.

In one embodiment of the present invention, frequency scalar values M_{A}, M_{B}, N_{A}, N_{B} are programmable and are stored in programmable registers. Specifically, scalars M_{A}, M_{B}, N_{A}, N_{B} are coupled to and are programmable through a controller 634, which can be implemented either in software or in hardware as microcontroller or a finite state machine. Controller 634 receives a request to switch input—REQSW 636, and additionally receives clock signals V-SYNC_{A} 606 and VBI_{A} 608 from graphics source A, and V-SYNC_{B} 610 and VBI_{B} 612 from graphics source B. Controller 634 then measures the phase difference between either the V-sync signals or the VBI signals of the two graphics sources. Using the measured phase difference as a feedback signal, controller 634 can then adjust the phase of V-sync and VBI from one graphics source relative to the other graphics source by synchronously changing the M and N values in the associated PLL.

Using the feedback loop, controller 634 continues measuring and adjusting the phase difference. When controller 634 determines that the phase difference is within a predetermined bound, it then generates a switch enable—OK2SWITCH 638. In one embodiment of the present invention, OK2SWITCH 638 is coupled to source select 226 in FIG. 2, which enables MUX 220 to flip the source.

Note that the above description allows clocks in both the active graphics source and the non-active graphics source to be changed. In particular, if the PLL scalar values being changed are associated with the source actively driving the display, it may be desirable to adjust the associated frequency slowly and smoothly. Also note that we may not need to obtain a perfect clock alignment to allow a switch. In one embodiment, controller 634 can be configured to align VBIs to obtain just enough overlap so that the switching operation does not cause visible artifacts. When the controller detects there is sufficient overlap, it asserts OK2SWITCH signal to complete the synchronization.

FIG. 6B presents a schematic of another technique for synchronizing timing signals between two graphics sources in accordance with an embodiment of the present invention.

In this embodiment, a single PLL 640 is used to synchronize timing signals between the graphics sources A and B. Note that there's no direct control of the PLL by a controller as in FIG. 6A. Instead, PLL 640 forms a closed loop with one of the timing generators.

As illustrated in FIG. 6B, timing generators 602 and 604 receive reference frequency inputs f_{REF}_{_{—}}_{A} 642 and f_{REF}_{_{—}}_{B} 644, respectively. The four outputs from timing generators 602 and 604: V-SYNC_{A} 606, VBI_{A} 608, V-SYNC_{B} 610, and VBI_{B} 612 are coupled to a four-to-two multiplexer MUX 646, which can select either V-SYNC_{A} 606 and V-SYNC_{B} 610, or VBI_{A} 608 and VBI_{B} 612 to its outputs. The outputs of MUX 646 are then coupled to the inputs of the phase detector of PLL 640. Note that either the V-sync signals or the VBI signals can be used for alignment in this embodiment.

Next, the VCO output from PLL 640 is coupled to and serves as the input reference frequency for one of the timing generators, and thereby completes the closed-loop with that timing generator. More specifically, the output from PLL 640 is first coupled to the inputs of two multiplexers MUX 648 and MUX 650, which also receive external clock signals EXTCLK_A 652 and EXTCLK_B 654 as inputs, respectively. The outputs of MUX 648 and MUX 650 are controlled by controller 656, which selects either the external clock source or the PLL output as the reference frequency input for a respective timing generator. Note that controller 656 receives an input from the phase detector of PLL 640 and detects if PLL 640 has locked based on the input.

During operation, assume that graphics source A is actively driving the display. Meanwhile, the VCO output of PLL 640 is selected as the reference frequency f_{REF}_{_{—}}_{B} 644 for timing generator 604 of the graphics source B. Hence, PLL 640 and timing generator 604 form a closed loop, which facilitates the selected timing signals (either V-sync or VBI) from the two timing generators to sync up. When controller 656 detects that PLL 640 has become phase-locked, it then switches the graphics source that drives the display from graphics source A to graphics source B during the next blanking interval. More specifically, in the following blanking interval, controller 656 switches the f_{REF}_{_{—}}_{B} input from PLL 640 to the external clock source EXTCLK_B 654. After the switching, PLL 640 can then be used for locking graphics source A to graphics source B, which is now actively driving the display.

Choosing Graphics Processors without Switching

In one embodiment of the present invention, instead of switching between two graphics processors to drive the same display device, the lower-performance, lower-power graphics processor always drives the display. In this embodiment, when additional graphics performance is required, the higher-performance processor takes over the graphics processing load, rendering its display image into the same frame buffer used by the lower-performance processor. When the system is operating in this manner, the lower-performance processor acts purely as a display output device, i.e., transferring image data from the frame buffer to the display, while the higher-performance device performs all the graphics processing. When less performance is required, the lower-performance device again takes over the graphics processing tasks, and the higher-performance device can be powered down accordingly.

### Computer System

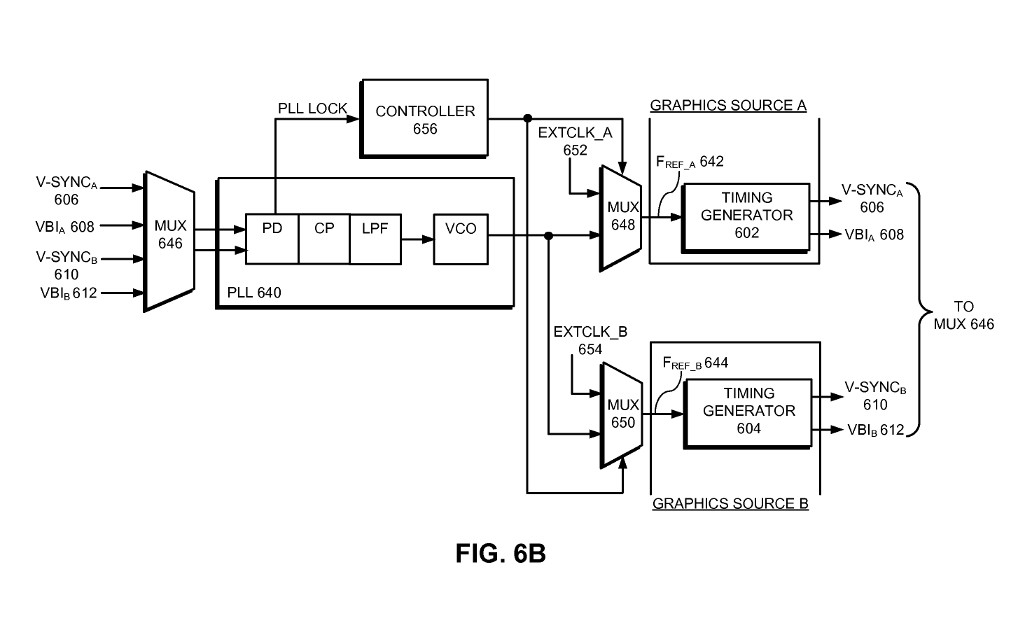

FIG. 7 illustrates a computer system 700 which includes two graphics processors in accordance with an embodiment of the present invention. More specifically, computer system 700 includes a processor 702, which is coupled to a bridge chip 704. Bridge chip 704 is itself coupled to main memory 706, display 714 and peripheral bus 708. Peripheral bus 708 can be used to access storage device 710.

Note that lower-performance, low-power graphics processor 712 is directly coupled to display 714 and always drives it. On the other hand, high-performance, high-power graphics processor 716 is coupled to graphics processor 712, and is typically powered down when it is not in use.

In one embodiment of the present invention, instead of rendering graphics into its own frame buffer, graphics processor 716 renders images directly into frame buffer 707 for graphics processor 712, wherein frame buffer 707 is located in main memory 706. In this embodiment, graphics processor 712 is responsible for displaying the graphics on display 714 by continuously refreshing display 714. Note that because in this embodiment the display is always driven by the same graphics processor and is refreshing from the same frame buffer, no switching hardware is required and there is no hardware switching transition to hide from the user.

In an alternative embodiment, when additional graphics processing power or additional security is needed, the system powers up graphics processor 716 to provide the additional graphics-rendering capacity. Graphics processor 716 renders images to its local frame buffer 722 that resides in a special-purpose graphics memory 720, which is coupled to (or integrated into) graphics processor 716. Note that special-purpose graphics memory 720 is more secure than main memory 706 because main memory 706 is typically shared among many different processes and applications. In this embodiment, graphics processor 712 must change the frame buffer (from which it is refreshing display 714) from its own frame buffer 707 to the frame buffer 722 of graphics processor 716. Because display 714 is always driven by the same graphics processor, no switching hardware is required. However, graphics processor 712 must be programmed to make the switch between frame buffers at the correct time (during the vertical blanking interval, for instance) to avoid a transition that is visible to the user.

### Switching Smoothly Between Graphics Sources

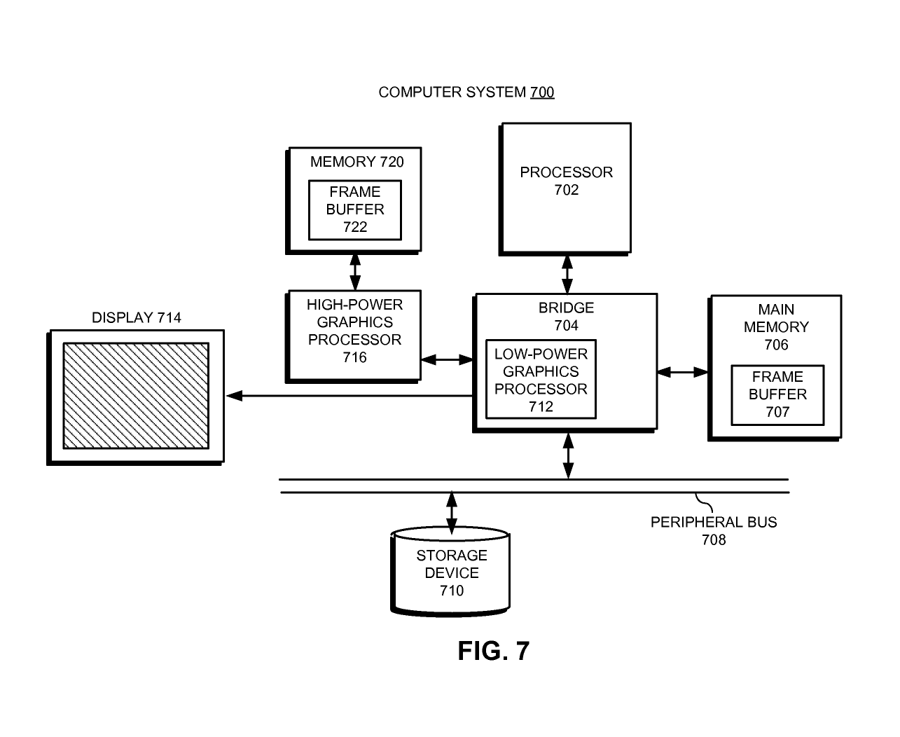

FIG. 8 presents a flow chart illustrating the process of switching from the first graphics source to the second graphics source in accordance with an embodiment of the present invention. At the start of this process, the lower-power internal graphics processor 712 (also referred to as a “GPU”) is rendering into frame buffer 707 in main memory 706, and display 714 is being refreshed from frame buffer 707 (step 802).

Next, the system determines whether more performance and/or more security is required (step 804). If not, the system returns to step 802.

Otherwise, if the system determines that more performance and/or more security is required, the system powers up external high-power graphics processor 716 (step 806). Then, external high-power graphics processor 716 renders an identical image into frame buffer 722 in graphics memory 720 (step 808).

Next, the system waits for a vertical blanking interval (VBI) (step 810). During this vertical blanking interval, internal low-power graphics processor 712 switches its refresh pointer from frame buffer 707 in main memory 706 to frame buffer 722 in graphics memory 720 (step 812). Next, internal low-power graphics processor 712 powers down except for its refresh circuits (step 814). At this point, the switching process is complete.

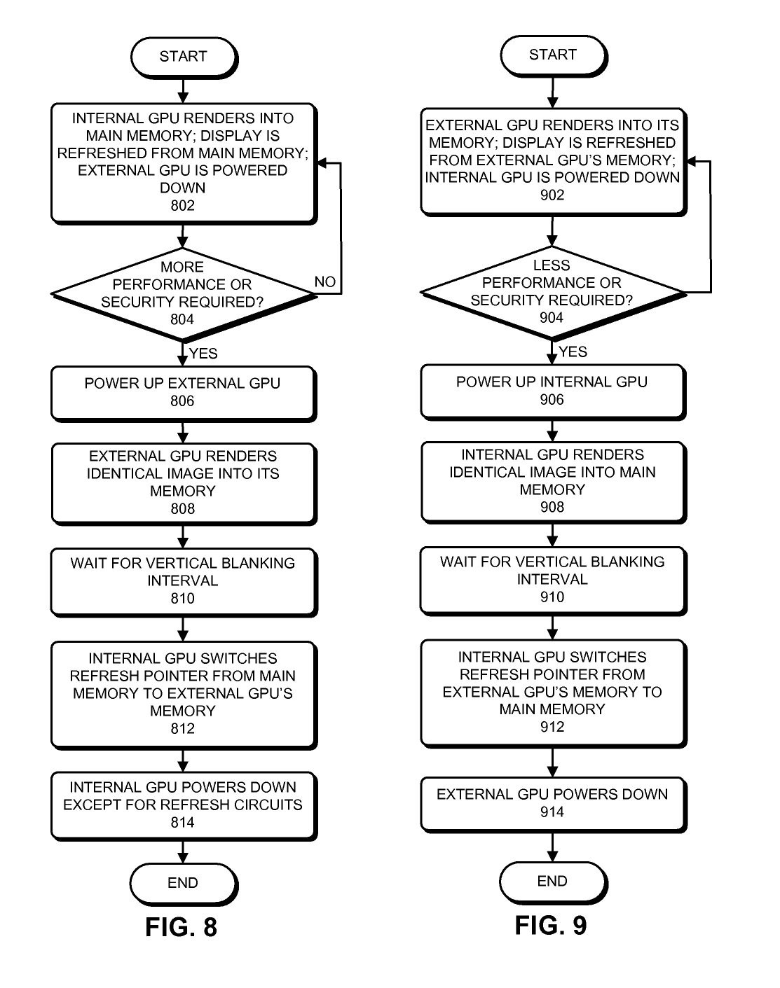

The switching can also take place in the other direction. More specifically, FIG. 9 presents a flow chart illustrating the process of switching from the second graphics source to the first graphics source in accordance with an embodiment of the present invention. At the start of this process, high-power internal graphics processor 716 is rendering into frame buffer 722 in graphics memory 720, and display 714 is being refreshed from frame buffer 722 (step 902).

Next, the system determines whether less performance and/or less security is required (step 904). If not, the system returns to step 902.

Otherwise, if the system determines that less performance and/or less security is required, the system powers up internal low-power graphics processor 712 (step 906). Then, low-power graphics processor 712 renders an identical image into frame buffer 707 in main memory 706 (step 908). Next, the system waits for a vertical blanking interval (step 910). During this vertical blanking interval, the internal low-power graphics processor 712 switches its refresh pointer from frame buffer 722 in graphics memory 720 to frame buffer 707 in main memory 706 (step 912). Next, the high-power graphics processor 716 powers down (step 914). At this point, the switching process is complete.

Note that it is also possible (and probably much easier) for software to simply fade out the display, then make the frame buffer switch and then fade the display back in. This is simpler because software does not have to make two graphics sources draw the same data into two frame buffers at the same time during the transition. Instead, the system can shut down one source, then start up the other source, and then switch frame buffers.

### Another Embodiment

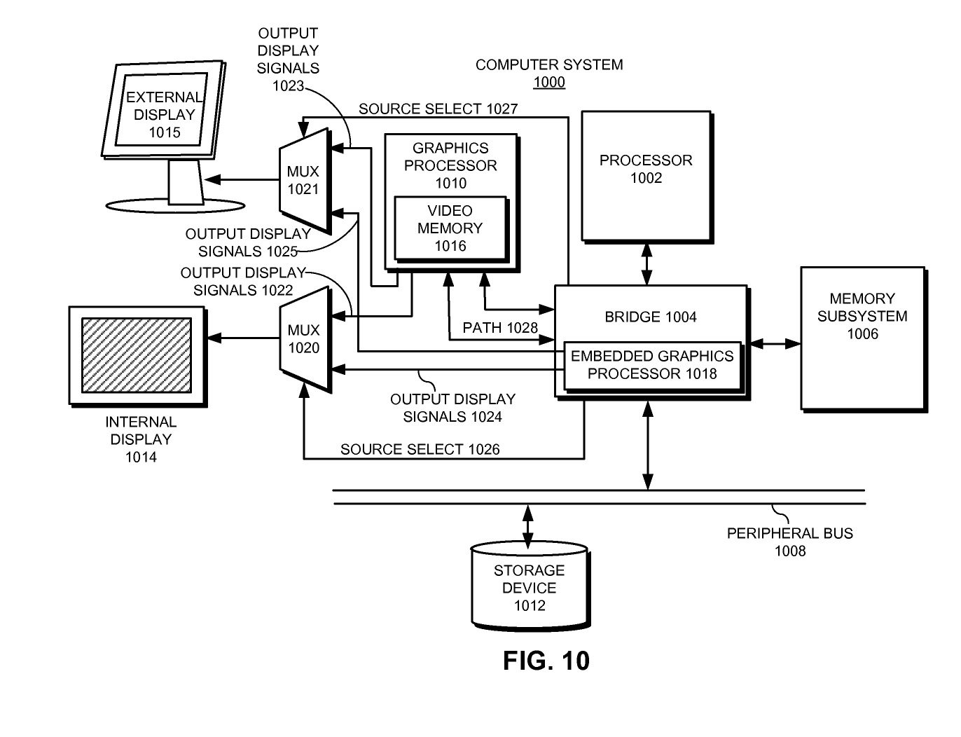

FIG. 10 illustrates a computer system 1000 which can switch between different graphics sources to drive both an internal display and an external display in accordance with an embodiment of the present invention. Note that in FIG. 10, two graphics processors (graphics processor 1010 and embedded graphics processor 1018) can each independently drive internal display 1014 and external display 1015. The graphics source which actively drives display 1014 is determined by multiplexer 1020, and the graphics source which drives display 1015 is determined by multiplexer 1021. Multiplexers 1020 and 1021 can select between the graphics processor 1010 and embedded graphics processor 1018.

Note that output display signals 1022 from graphics processor 1010, and output display signals 1024 from embedded graphics processor 1018 are coupled to inputs of a multiplexer (MUX) 1020. Similarly, output display signals 1023 from graphics processor 1010, and output display signals 1025 from embedded graphics processor 1018 are coupled to inputs of MUX 1021. Note that each graphics processor has separate output display signals for driving the two displays. (This is because the two displays can use different display signaling protocols, and are in general different in pixel resolution, color depth, color balance, etc.).

The output of MUX 1020 is controlled by source select 1026, which determines which one of the two graphics sources should drive internal display 1014. Similarly, the output of MUX 1021 is controlled by source select 1027, which determines which one of the two graphics sources will drive external display 1015. In this embodiment, source selects 1026 and 1027 are outputs of bridge chip 1004, which contains circuitry for generating source selects 1026 and 1027. Note that source selects 1026 and 1027 can also be produced by a logic block which is located outside of bridge 1004.

The output display signals from the selected graphics source are coupled to the inputs of display 1014 and display 1015. Although the selecting device is shown as a multiplexer, it can also include any other type of selecting device, such as simple wired-OR logic.

In one embodiment of the present invention, graphics processor 1010 is a high-performance graphics processor unit (GPU), which consumes a large amount of power, whereas embedded graphics processor 1018 is a lower-performance GPU, which consumes a smaller amount of power. In this embodiment, when the graphics processing load is light, the system switches the graphics source from graphics processor 1010 to embedded graphics processor 1018 to drive displays 1014 and 1015, and subsequently powers down graphics processor 1010 entirely, thereby saving power. On the other hand, when the graphics processing load becomes heavy again, the system switches graphics source from embedded graphics processor 1018 back to graphics processor 1010.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for switching between frame buffers which are used to refresh a display, comprising:
refreshing the display from a first frame buffer which is located in a first memory;
receiving a request to switch frame buffers for the display; and
in response to the request, reconfiguring data transfers to the display so that the display is refreshed from a second frame buffer which is located in a second memory.

2. The method of claim 1,
wherein the first memory is a main memory, which is accessible by numerous applications and is hence insecure; and
wherein the second memory is a secure frame buffer which is located outside of main memory.

3. The method of claim 2, wherein switching the display so that the display is refreshed from the second frame buffer additionally involves:
transferring data which is used to refresh the display so that the data completely bypasses the insecure main memory; and
encrypting the data while the data is stored in the second frame buffer and while the data is in transit to and from the second frame buffer.

4. The method of claim 1, wherein prior to receiving the request to switch frame buffers, the method further comprises:
determining a security requirement for data associated with the display; and
generating the request to switch frame buffers based on the determined security requirement.

5. The method of claim 1, wherein prior to receiving the request to switch frame buffers, the method further comprises:
monitoring a level of graphics-processing load for the display; and
generating the request to switch based on the level of graphics-processing load.

6. The method of claim 1, wherein prior to receiving the request to switch frame buffers, the method further comprises:
measuring a temperature in a computer system which contains the display; and
generating the request to switch based on the measured temperature.

7. The method of claim 1,
wherein switching the display so that the display is refreshed from the second frame buffer additionally involves switching a graphics processing unit (GPU) which performs rendering operations for the display; and
wherein the GPU is switched between a low-power GPU which renders to the first frame buffer and a high-power GPU which renders to the second frame buffer.

8. The method of claim 7, wherein prior to switching from the low-power GPU to the high-power GPU, the method further comprises substantially synchronizing the low-power GPU's output display signals and the high-power GPU's output display signals, thereby facilitating a seamless transition which does not disrupt graphical output on the display.

9. The method of claim 8, wherein substantially synchronizing the output display signals involves using one or more phase-locked loops (PLL).

10. The method of claim 1, wherein the switching takes place during a blanking interval associated with a blanking signal for the display.

11. An apparatus that selectively switches between frame buffers which are used to refresh a display, comprising:
a first frame buffer located in a first memory;
a second frame buffer located in a second memory;
one or more refresh circuits configured to selectively refresh the display from either the first frame buffer or the second frame buffer; and
a switching mechanism configured to switch the refreshing of the display between the first frame buffer and the second frame buffer upon receiving a request to switch.

12. The apparatus of claim 11,
wherein the first memory is a main memory, which is accessible by numerous applications and is hence insecure; and
wherein the second memory is a secure frame buffer which is located outside of main memory.

13. The apparatus of claim 12,
wherein the switching circuit is configured to channel data which is used to refresh the display so that the data completely bypasses the insecure main memory; and
wherein the apparatus additionally comprises encryption circuitry which is configured to encrypt the data while the data is stored in the second frame buffer and while the data is in transit to and from the second frame buffer.

14. The apparatus of claim 11, wherein the switching mechanism is configured to:
determine a security requirement for data associated with the display; and
generate the request to switch frame buffers based on the determined security requirement.

15. The apparatus of claim 11, wherein the switching mechanism is configured to:
monitor a level of graphics-processing load for the display; and
generate the request to switch based on the level of graphics-processing load.

16. The apparatus of claim 11, wherein the switching mechanism is configured to:
measure a temperature in a computer system which contains the display; and
generate the request to switch based on the measured temperature.

17. The apparatus of claim 11,
wherein while switching between the first frame buffer and the second frame buffer, the apparatus is configured to switch a graphics processing unit (GPU) which performs rendering operations for the display; and
wherein the GPU is switched from a low-power GPU which renders to the first frame buffer to a high-power GPU which renders to the second frame buffer.

18. The apparatus of claim 17, wherein prior to switching from the low-power GPU to the high-power GPU, the switching mechanism is configured to substantially synchronize the low-power GPU's output display signals and the high-power GPU's output display signals, thereby facilitating a seamless transition which does not disrupt graphical output.

19. The apparatus of claim 18, wherein substantially synchronizing the output display signals involves using one or more phase-locked loops (PLL).

20. The apparatus of claim 11, wherein the switching takes place during a blanking interval associated with a blanking signal for the display.

21. A computer system that selectively switches between frame buffers which are used to refresh a display, comprising:
a processor;
a main memory coupled to the processor;
a first frame buffer located in the main memory;
a second frame buffer located in a second memory;
one or more refresh circuits configured to selectively refresh the display from either the first frame buffer or the second frame buffer; and
a switching mechanism configured to switch the refreshing of the display between the first frame buffer and the second frame buffer upon receiving a request to switch.

22. A computer system that switches between a first graphics processor and a second graphics processor to drive a first display and/or a second display, comprising:
a processor;
a memory;
the first graphics processor;
the second graphics processor;
the first display;
the second display;
a first switch which selectively couples either the first graphics processor or the second graphics processor to the first display; and
a second switch which selectively couples either the first graphics processor or the second graphics processor to the second display.

23. The computer system of claim 22, further comprising a synchronization mechanism configured to substantially synchronize the first graphics processor's output display signals and the second graphics processor's output display signals, thereby facilitating a seamless switching process which does not disrupt graphical output.

24. The computer system of claim 22,
wherein the first graphics processor is a high-power graphics processing unit (GPU); and
wherein the second graphics processor is a low-power GPU.

25. The computer system of claim 22,
wherein the first display is an internal display integrated into the computer system; and
wherein the second display is an external display which is coupled to the computer system.
